(19) United States
(12) Patent Application Publication
(10) Pub. No.: US 2008/0191580 A1
(43) Pub. Date: Aug. 14, 2008

(54) Harmonic Energy Exchange Device

(76) Inventor: Harold Stanley Deyo, Pueblo West, CO (US)

Correspondence Address: HAROLD S DEYO, JR., 241 S. DOS PALOS DRIVE, PUEBLO WEST, CO, 81007, US

(21) Appl. No.: 11/675,060

(22) Filed: Feb. 14, 2007

(51) Int. Cl. H02N 11/00

(52) U.S. Cl. 310/300

(57) ABSTRACT

This invention converts inertial impulses into electric currents. Specifically, it converts impulses created by the impacts of high-energy particles from the Sun and other cosmic sources into the Earth's Magnetosphere and the varying D, E, F1 and F2 layers of its Ionosphere to controlled electric currents. This invention presents a new method of utilizing energy from the Sun and other sources of high energy articles as a virtually, inexhaustible, alternative-energy source for the world.

### BACKGROUND OF THE INVENTION

1. Field of Invention

This invention relates to the conversion of impact energies created by the collision of high-speed cosmic particles and electromagnetic radiations with “Earth's Outer Layers” to produce inertial waves in the dielectric Troposphere which are subsequently converted into electricity by this invention.

The term “Earth's Outer Layers” refers to: Earth's Magnetosphere, Van Allen Belts, Ionosphere, Mesosphere, and Stratosphere as illustrated in FIG. 2

2. Description of the Prior Art

One day while reading an old scientific magazine I saw a small article on the research of Dr. John Trump of MIT (the basis for an electrostatic generator patented later by Onezime P. Breaux in U.S. Pat. No. 4,127,804). The article talked about a series of experiments which Dr. Trump had performed with a 2-plate, capacitor in a vacuum dielectric. Briefly, he discovered that by varying the distance between the two plates one could produce current flows in one direction or the other between either of the plates and ground.

The Solar Wind strikes “Earth's Outer Layers” constantly as do many other cosmic particles. At any given instant of time, the vector product of these impacts produces either a net pressure increase or decrease in the Troposphere. This creates random waves of pressure in the “Earth's Outer Layers” as one charged “plate” moves in relation to the oppositely-charged Earth's surface as the other “plate”. This variation of pressure in the “Earth's Outer Layers” is equivalent to moving an outer “plate” back and forth toward the Troposphere and the Earth's surface as the inner “plate”—thus giving rise to variations in voltage on both “plates”. In this case the Troposphere (see FIG. 2) acts as the dielectric medium instead of the vacuum in the Trump experiments. Furthermore, the Troposphere, itself, is also compressed and decompressed by these random waves of pressure on the “Earth's Outer Layers”. Thus, I reasoned if one could create a charged envelope or field of sufficient voltage within the Troposphere, one could convert these random pressure waves in the dielectric Troposphere into current flow on the Earth's surface.

As “Earth's Outer Layers” surround the planet, any impact waves propagate throughout all of them when they are present—even to the nighttime side of the planet. Thus, I also reasoned one could extract power from these impacts anywhere on Earth's surface or in its atmosphere whether it be day or night. The pressure waves on the dark side of Earth would be less energetic than those occurring on the daytime side because the nighttime layers of the Ionosphere are compressed so much that the D-Layer of the Ionosphere disappears at night and the F1 and F2-Layers of the Ionosphere combine into one F-Layer. I calculated the available energy from these impact waves would be significantly less by 30-45% depending upon one's location on the night side of the planet in respect to the terminator.

Many years ago around 1900 Dr Nikola Tesla built and tested a device to extract energy from the Sun using an apparatus which forms part of my own invention (see U.S. Pat. Nos. 685,957 an 685,958 dated 5 Nov. 1901).

Subsequently, Dr. Thomas Henry Moray, another inventor and student of these Tesla patents made a device which apparently accessed the same source of energy but with a method different than my own. As Dr. Moray was never granted a patent for his device I cannot be certain that his work is considered prior art but I list it here as part of my due diligence. Apparently, he had trouble explaining the source of energy his device was converting to the patent reviewer and was, thus, not granted a patent for his impressive work. Dr. Moray's public disclosure of certain aspects of his invention are public knowledge through his published lectures and his book, “The Sea of Energy in Which the Earth Floats'—published in 1931.

Since the beginning of the 20^{th} Century mankind has been looking for new sources of electric power to feed the ever-increasing energy demands of the human population. In the last half of the 19^{th} Century coal, whale oil, human and animal labor, moving water, wind and wood were main sources of energy. However, in the first quarter of the 20^{th} Century mankind began to use more electricity produced by hydroelectric generators and other generators producing electricity by combustion of fossil fuels. With increasing use of gasoline engines and the increasing use of electrical appliances the demand for electricity accelerated the addition of heat and greenhouse gases into the Earth's ecosystem.

In the last half of the 20^{th} Century many forward-thinking individuals began looking for alternate energy sources to reduce the emissions of greenhouse gases. All of the alternate energy systems investigated and/or developed in the last 56 years have had significant drawbacks to their usage as the main energy supply for the needs of humanity.

Some of those alternate energy systems were nowhere near as efficient as the existing systems. Some of the alternate energy systems still introduced extra heat into the environment like the existing fossil fuel and nuclear energy systems. And, yet, others produced even more greenhouse gases than the existing energy systems. Some of the new systems used food resources to produce combustible fuels which, consequently, reduced the food resources of the planet. Among the leaders in the new energy sources was and is nuclear energy which produces extra heat, toxic wastes and materials which can be used in nuclear weapons. Hydroelectric energy sources do not add heat to the ecosystem but they are not an inexhaustible resource as they depend upon rainfall which is diminishing as global warming increases. Wind energy resources do not add heat to the ecosystem but they are not constant and require expensive conversion and storage equipment.

The ideal energy source for mankind will not add heat to the planet's ecosystem, will not produce by-product green house gases; will not deplete our food and water resources; will not produce toxic wastes; however, it will be portable, self-replenishing and constantly available in real time anywhere on Earth and in useful quantities.

Our major source of natural energy on Earth is the Sun. Energy from the Sun enters the Earth's ecosphere by particle bombardment, radiated electromagnetic energy, gravitational variations and magnetic processes. Mankind has developed various methods of capturing energy from the Sun already. Silicon-based solar cells convert light in a narrow bandwidth into electron flows. These cells are—at most—only 50% efficient and only work when the Sun is shining on them and at an optimum angle. Wind turbines only work when there is wind to power them and are—for the most part—not portable. Devices to convert wave action in the oceans only work when there are waves created by the wind and tidal effects caused by gravitational variations; and they are not portable enough to be used in common transportation devices.

I concluded if mankind could find an inexpensive method of obtaining electricity from the Sun in some form that worked both day and night and which was already flowing into the Earth's ecosystem, we might be able to develop a clean and self-replenishing energy source which would add no extra heat to our ecosystem, would not alter our planetary albedo and might well be made in a portable form.

### SUMMARY OF THE INVENTION

The Harmonic Energy Exchange Device (or “HEED”) offers an interim solution to Earth's dwindling fossil fuel resources. It utilizes a previously untapped energy resource which exists throughout the known Universe. By the very nature of the invention, it only interrupts the flow of energy from the Sun and all the other cosmic sources of high-energy particles on their normal journey to the Earth by way of The Outer Layers.

The invention does not add energy to the normal thermodynamic equilibrium of the planet and its associated outer layers. The invention does not produce wastes—toxic or otherwise. It does not produce harmful gases; and in some embodiments it could even assist in the rebuilding of our thinning ozone shield. Use of this invention will eventually remove mankind's dependence on fossil fuels and create new occupations. It will be cheap enough that homeowners will be able to install their own HEED and sell back energy to the grid until such time as every home has their own HEED and civilization has completely weaned itself from the use of fossil fuels and nuclear energy in its current form.

### BRIEF DESCRIPTION OF DRAWING

FIG. 1: Is the preferred embodiment of the circuit diagram of my invention incorporating references to external stimuli which are used to activate the circuit. It represents a parallel tuned circuit to store the energy.

FIG. 2: Is an illustration of the Earth and it immediate environment as a global capacitor where The Outer Layers form one plate and the Earth's surface form the other plate and both are separated by the Troposphere as a dielectric medium.

FIG. 3: Is an alternate embodiment of the circuit diagram of my invention incorporating references to external stimuli which are used to activate the circuit. It represents the use of a series tuned circuit to store the energy.

### DETAILED DESCRIPTION OF A PREFERRED EMBODIMENT OF THE INVENTION

Be it known that I, Harold Stanley Deyo, Jr, a citizen of both The United States of America and The Commonwealth of Australia, residing in the community of Pueblo West in Pueblo County, Colorado have invented an Harmonic Energy Exchange Device which converts dynamic pressures in the ambient media around Earth to controlled electric currents.

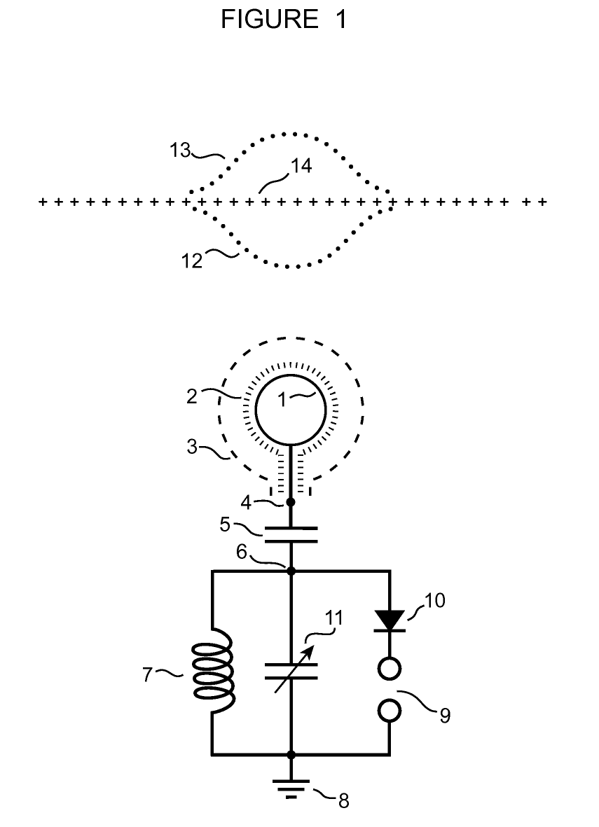

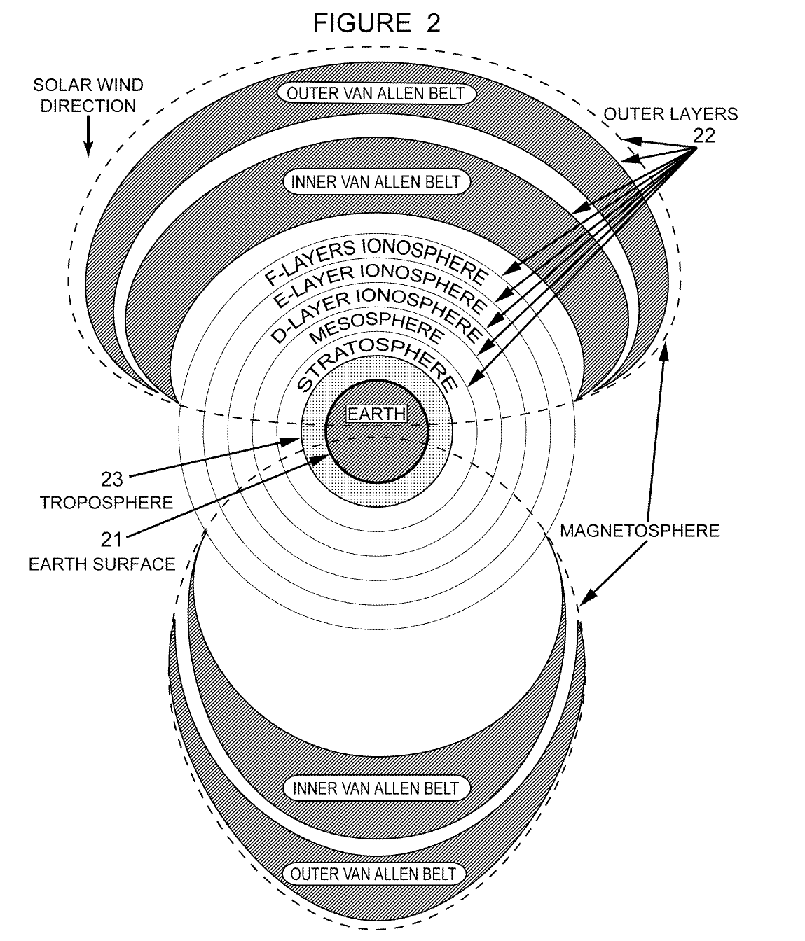

This invention as represented in FIG. 1 is unique in that it is designed to extract electricity from random pressure waves propagated in the Troposphere 14 by impacts of the solar wind and other cosmic particles with the Earth's “The Outer Layers” 22 of FIG. 2.

In FIG. 1, the Troposphere 14 in its rest state is represented by the line of “+” marks 14. The convergent or compression state 12 of the random waves in the Troposphere 14 is represented by the lower line of dots while the divergent or decompression state 13 of the random waves in the Troposphere 14 is represented by the upper line of dots. The preferred embodiment of my invention FIG. 1 is a method of coupling a parallel, resonant, electrical circuit to these random pressure waves to extract electricity from them.

As Dr John Trump's research and Onezime P. Breaux's U.S. Pat. No. 4,127,804 show, when one plate of a charged capacitor is moved closer to or farther from the other plate of that capacitor a voltage change appears on both plates of that capacitor. Furthermore, the electric field gradient between those plates changes as the plates are moved in this manner. Thus they have described a method of converting mechanical energy into electrical current by simply varying the plate spacing over time which can be expressed as ds/dt where “ds” is the change in spacing and “dt” is the change in time.

As illustrated in FIG. 2, The Outer Layers can be viewed as one plate of a capacitor comprised of the Earth's surface itself as one plate 21 and Earth's outer layers as the other plate 22 where the Earth's Troposphere 23 serves as the dielectric medium separating the two plates. There is a charge between these plates which varies extremely rapidly but not with a constant period. At any given instant, the vector product of all the impacts by the cosmic particles with The Outer Layers 22 will create a pressure wave in The Outer Layers 22 which will manifest in the Troposphere 23. Whatever that vector product is, it will alter the field gradient in the dielectric Troposphere 23. That alteration will either increase or decrease the effective spacing between “plates” 22 and 23.

In order to capture and convert the resulting voltage variations produced at or near the Earth's surface 21 of FIG. 2, this invention creates its own, localized stress field 3 of FIG. 1 established in the Troposphere 23 of FIG. 2 with a charged, conductive surface 1 of FIG. 1 which is encased in high-voltage insulation 2 of FIG. 1 and extending into the Troposphere 23 of FIG. 2.

In FIG. 1, a series of high-voltage, starting pulses is applied across points 4 and 6 on opposite sides of a capacitor 5 to create the localized stress field 3. As these high-voltage starting pulses are applied, the parallel resonant circuit formed by inductor coil 7 and variable capacitor 11 both referenced to ground 8 is stimulated into resonance within the bandwidth determined by the values of these circuit components. Tuning of this circuit is effected through variable capacitor 11. The high voltage charge on conductive surface 1 of FIG. 1 is maintained by the parallel tuned circuit formed by inductor coil 7 and variable capacitor 11.

Then as the random, pressure waves propagate throughout the Troposphere 23 of FIG. 2, the localized stress field 3 of FIG. 1 is oscillated by the compression wave front 12 and the decompression wave front 13—both of FIG. 1 which creates voltage changes on capacitor 5.

In FIG. 1, the resulting voltages changes on capacitor 5 will add energy to the parallel resonant circuit formed by inductor coil 7 and variable capacitor 11 which acts as a tank circuit to store the energy which has been passed to it. As energy builds in the parallel circuit the voltage of the circuit rises until a spark discharge occurs across the gap 9 also referenced to ground 8. The current will only discharge in one direction as determined by diode 10. The circuit will work without diode 10 but a diode is used here as one method to keep from draining all the energy from the tank circuit when a discharge occurs.

This resonant circuit can be tuned to various bandwidths to maximize the efficiency of the conversion process depending upon location of the device, time of day, temperature variations, relative humidity and other variables in the ambient Troposphere 23 of FIG. 2 around the conductive surface 1 of FIG. 1. A resistive load to extract power from the resonant circuit can be used instead of the spark gap 9 of FIG. 1.

This preferred embodiment uses a parallel, tuned circuit to access a wide range of frequencies usually to be found in the range of 4.5 to 7 MHz. This range encompasses the major, naturally-occurring, resonant frequencies found in the ionosphere.

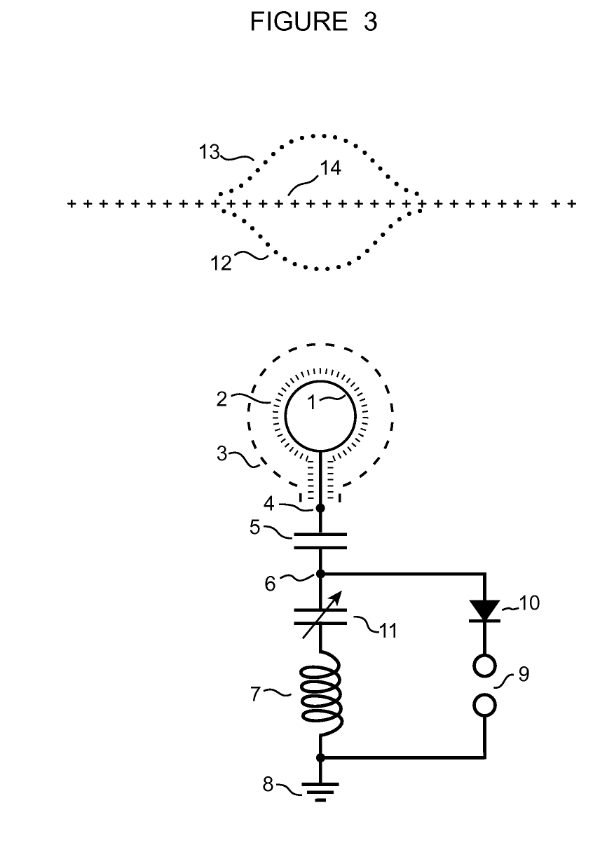

A second embodiment of this invention as shown in FIG. 3 replaces the parallel tuned circuit formed by inductor coil 7 and variable capacitor 11 in FIG. 1 placed in parallel to each other and referenced to ground 8 in FIG. 1. This second embodiment forms a series tuned circuit formed by inductor coil 7 and variable capacitor 11 in FIG. 3 placed in series to each other and referenced to ground 8 of FIG. 3. It differs from the preferred embodiment only in the placement of variable capacitor 11 of FIG. 3 so that it is in series with coil 7 of FIG. 3.

This embodiment limits the frequency range and, hence, the energy the system will store when compared to the preferred embodiment. It produces higher voltages across the spark gap 9 of FIG. 3 than those produced in the preferred embodiment across the spark gap 9 of FIG. 1.

1. An apparatus for coupling to the pressure waves created in the Earth's Magnetosphere and the varying D, E, F1 and F2 layers of its Ionosphere by the impacts of various high-energy particles from both our Sun and other cosmic sources.

2. An electrical circuit for harmonically converting the pressure waves described in claim (1) into periodic electric current discharges.
